(19) United States
(12) Patent Application Publication
(10) Pub. No.: US 2011/0020692 A1
(43) Pub. Date: Jan. 27, 2011

(54) SEPARATOR FOR METAL HALIDE BATTERY

(76) Inventors: Takashi Ikemoto, Tokyo (JP); Takeshi Onizawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/866,425

(22) PCT Filed: Feb. 4, 2009
(86) PCT No.: PCT/JP2009/051858

§ 371 Date: Oct. 4, 2010

(30) Foreign Application Priority Data
Feb. 6, 2008 (JP) 2008-026476 2008
Mar. 27, 2008 (JP) 2008-082591 2008

(51) Int. Cl. H01M 2/16; H01M 12/08

(52) U.S. Cl. 429/144

(57) ABSTRACT

It is an object of the present invention to provide a separator for a metal halide battery which can maintain a low bromine permeability for a long duration and can maintain battery performance for a long duration. The present invention provides a separator for a metal halide battery having a bromine diffusion coefficient after 240 hours of less than 4.2×10⁻⁹ mol/cm²/sec.

### TECHNICAL FIELD

The present invention relates to a separator for a metal halide battery.

### BACKGROUND ART

Generally, as the separator used in a metal halide battery, and especially in a zinc-bromine battery, an ion-exchange membrane, a fluororesin porous membrane or a polyolefin porous membrane is used.

Patent Document 1 describes a separator which suppresses the occurrence of warping by defining the thickness, and which has an olefinic plastic and hydrous silica as main components. Patent Document 2 describes a separator which physically suppresses bromine permeability by subjecting to a dipping treatment with a silane coupling agent to add an organic group to the surface. Patent Document 3 describes a separator which has a low bromine permeability by defining the number of silica atoms present on the separator surface. Patent Document 4 describes a technique for improving stress crack resistance and suppressing a decrease in Coulombic efficiency by defining the molecular weight of polyethylene and defining the number of silica atoms present on the separator surface. Patent Document 5 describes a separator which uses a polyethylene microporous membrane that has suppressed bromine diffusion by increasing the surface area of the used silica. Patent Document 6 describes a separator that has suppressed bromine diffusion by supporting a fluorinated ion-exchange resin on the surface of a substrate membrane.

### [Patent Document 1] Japanese Patent Publication No. 5-27233

### [Patent Document 2] Japanese Patent Application Laid-Open No. 1-157070

### [Patent Document 3] Japanese Patent Application Laid-Open No. 1-157071

### [Patent Document 4] WO2001/091207

### [Patent Document 5] Japanese Patent Application Laid-Open No. 10-64500

### [Patent Document 6] Japanese Patent Application Laid-Open No. 4-312764

### DISCLOSURE OF THE INVENTION

### Problems to be Solved by the Invention

It is desirable for the separator used in a metal halide battery, and especially in a zinc-bromine battery, to maintain a low bromine permeability for a long duration. More specifically, if bromine permeates the separator, self-discharge of the battery tends to be promoted, which can lead to battery performance deteriorating.

However, for a separator for a metal halide battery, and especially for a zinc-bromine battery, all of the separators described in Patent Documents 1 to 6 still have room for improvement from the perspectives of maintaining a low bromine permeability for a long duration, and maintaining battery performance for a long duration by suppressing self-discharge over a long time period.

The present invention provides a separator for a metal halide battery which can maintain a low bromine permeability for a long duration and can maintain battery performance for a long duration.

### Means for Solving the Problems

To solve the above-described problems, the present inventors discovered a means for physically and chemically separating the surface of a polyolefin microporous membrane and a bromine complex, by coating the polyolefin microporous membrane, which serves as a substrate membrane, with an inorganic porous layer which includes an inorganic filler and an inorganic binder. Based on this, the present inventors discovered that a separator for a metal halide battery, which can maintain a low bromine permeability for a long duration and can maintain battery performance for a long duration, can be realized, thereby completing the present invention.

Specifically, the present invention is as follows.

[1] A separator for a metal halide battery having a bromine diffusion coefficient after 240 hours of less than 4.2×10⁻⁹ mol/cm²/sec.
[2] The separator according to [1], which has an electrical resistance of 0.005 ω·100 cm²/sheet or less.
[3] The separator according to [1] or [2], which has a tensile breaking strength of 2.5 MPa or more.
[4] A separator for a metal halide battery comprising:

a polyolefin porous layer which comprises a polyolefin as a main component; and

an inorganic filler porous layer which is laminated on the polyolefin porous layer and which comprises an inorganic filler (I) as a main component.

[5] The separator according to [4], wherein the inorganic filler porous layer further comprises a binder.

[6] The separator according to [5], wherein the binder is an inorganic binder.

[7] The separator according to [6], wherein the inorganic binder comprises a metal oxide as a main component.

[8] The separator according to any one of [4] to [7], wherein the inorganic filler (I) has a dispersion average particle size of 0.005 to 5 μm.

[9] The separator according to any one of [4] to [8], wherein the inorganic filler (I) comprises silicon oxide as a main component.

[10] The separator according to any one of [4] to [9], wherein the inorganic filler (I) is hydrophilic.

[11] The separator according to any one of [4] to [10], wherein the polyolefin porous layer further comprises an inorganic filler (II).

[12] The separator according to [11], wherein the inorganic filler (II) comprises silicon oxide as a main component.

[13] The separator according to [12], wherein a ratio (Si/C ratio) between the number of silicon atoms and the number of carbon atoms on a surface of the polyolefin microporous membrane facing the inorganic filler porous layer is 0.005 to 0.45.

[14] The separator according to any one of [1] to [13], which is for a zinc-bromine battery.

### ADVANTAGES OF THE INVENTION

The separator for a metal halide battery according to the present invention is suitable as a separator for a metal halide battery which can maintain a low bromine permeability for a long duration, and can maintain battery performance for a long duration

### BRIEF DESCRIPTION OF THE DRAWINGS

FIG. 1 illustrates a schematic diagram of a cell for bromine diffusion coefficient measurement; and

FIG. 2 illustrates a configuration diagram of a zinc-bromine secondary battery simple cell used for Coulombic efficiency measurement.

### DESCRIPTION OF SYMBOLS

1 Silicon rubber stopper
2 Separator
3 Stirrer chip
4 Positive electrode cell
5 Negative electrode cell
11 Single cell
12 Positive electrode chamber
13 Negative electrode chamber
14 Separator
15 Positive electrode
16 Negative electrode
17 Positive electrode electrolyte
18 Negative electrode electrolyte
19 Storage tank for a positive electrode solution
20 Storage tank for a negative electrode solution
21 Pump
22 Pump

### BEST MODE FOR CARRYING OUT THE INVENTION

The best mode for carrying out the invention (hereinafter abbreviated as “embodiment”) will now be described in more detail below. However, the present invention is not limited to the following embodiment. The present invention may be carried out while making various modifications within the scope of the invention.

The separator for a metal halide battery according to the present embodiment preferably has a polyolefin porous layer, which is a microporous membrane made from a polyolefin, and an inorganic filler porous layer (hereinafter, “inorganic porous layer”) which is laminated on the polyolefin porous layer and which includes an inorganic filler (I) as a main component. More preferably, the separator for a metal halide battery according to the present embodiment has an inorganic porous layer, which includes the inorganic filler (I) and an inorganic binder, on at least one face of the polyolefin microporous membrane.

In the present embodiment, the term “main component” means that a specific component has, as a ratio of the matrix components including the specific component, preferably 50 mass % or more, more preferably 70 mass % or more, and even more preferably 90 mass % or more, and can even mean 100 mass %.

### Inorganic Porous Layer

The inorganic porous layer according to the present embodiment preferably includes the inorganic filler (I) and a binder. The binder is preferably an inorganic binder.

The inorganic filler (I) is preferably stable against bromine, and is preferably a metal oxide. If the inorganic filler (I) is a metal oxide, from the perspective of obtaining low bromine permeability, it is preferred to include that metal oxide as the main component.

Examples of the metal oxide include an oxide ceramic such as alumina, silica (silicon oxide), titania, zirconia, magnesia, ceria, yttria, zinc oxide, and iron oxide; a nitride ceramic such as silicon nitride, titanium nitride, and boron nitride; a ceramic such as silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth, and silica sand; and glass fiber. These metal oxides may be used alone, or a plurality may be mixed together.

From the perspective of maintaining low bromine permeability even after a long period has elapsed, it is preferred that this inorganic filler (I) includes as a main component at least one kind of metal oxide selected from the group consisting of alumina, titania, and silica. More preferably, the metal oxide includes silica as a main component.

From the perspectives of physically and chemically separating the surface of the polyolefin microporous membrane and the bromine complex, and obtaining low bromine permeability, this inorganic filler (I) is preferably a hydrophilic inorganic filler.

The hydrophilicity of the inorganic filler can exhibit a methanol wettability value (hereinafter, “M value”). This M value is the methanol volume % of an aqueous solution of methanol at which the inorganic filler can settle out. More specifically, the M value is the methanol volume % of the minimum concentration of aqueous solution at which the inorganic filler settles out when the inorganic filler is placed into aqueous methanol solutions having different concentrations. Generally, if the hydrophilicity of the inorganic filler surface is low, it is more difficult for the inorganic filler to disperse and settle out in the aqueous methanol solution. Therefore, the lower hydrophilicity is, the higher the M value tends to become.

To obtain a low bromine permeability, the inorganic filler preferably has an M value of 20 or less, more preferably 10 or less, still more preferably 5 or less, especially preferably 3 or less, and extremely preferably 1 or less.

The dispersion particle size of the inorganic filler (I) is, as a dispersion average particle size, from the perspective of obtaining a high ion permeability, preferably 0.005 μm or more, more preferably 0.01 μm or more, and still more preferably 0.02 μm or more. On the other hand, from the perspectives of increasing the density of the inorganic porous layer and obtaining a low bromine permeability, the dispersion particle size is preferably 5 μm or less, more preferably 3 μm or less, still more preferably 2 μm or less, and especially preferably 1 μm or less.

The dispersion average particle size in the present embodiment is a value measured based on a measurement method described in the following Examples.

The above-described binder may be an organic binder, an inorganic binder, or a combination thereof. From the perspective of maintaining a low bromine permeability for a longer duration, the binder is preferably an inorganic binder. Examples of organic binders include resin binders. It is preferred that that the organic binder can bind the inorganic filler (I), is insoluble in the electrolyte of the metal halide battery, and is electrochemically stable in the usage range of the metal halide battery.

Examples of resin binders include polyolefins such as polyethylene and polypropylene, fluororesins such as polyvinylidene fluoride and polytetrafluoroethylene, fluorine-containing rubbers such as a vinylidene fluoride-hexafluoropropylene-tetrafluoroethylene copolymer and an ethylene-tetrafluoroethylene copolymer, a styrene-butadiene copolymer and hydrides thereof, an acrylonitrile-butadiene copolymer and hydrides thereof, an acrylonitrile-butadiene-styrene copolymer and hydrides thereof, a methacrylate-acrylate copolymer, a styrene-acrylate copolymer, an acrylonitrile-acrylate copolymer, rubbers such as ethylene propylene rubber, polyvinyl alcohol, and polyvinyl acetate, resins having a melting point and/or glass transition temperature of 180° C. or more such as polyphenylene ether, polysulfone, polyethersulfone, polyphenylene sulfide, polyetherimide, polyamide imide, polyamide, and polyester. These resin binders may be used alone, or a plurality may be mixed together.

When using a polyolefin for the resin binder, from the perspective of fabricability, the polyolefin has an intrinsic viscosity of, as a lower limit, preferably 0.07 dl/g or more, more preferably 0.1 dl/g or more, and even more preferably 0.2 dl/g or more. As an upper limit, the intrinsic viscosity is preferably 37 dl/g or less, more preferably 15 dl/g or less, even more preferably 11.5 dl/g or less, and still even more preferably 7 dl/g or less.

It is preferred that the inorganic binder can bind the inorganic filler (I), is insoluble in the electrolyte of the metal halide battery, and is electrochemically stable in the usage range of the metal halide battery.

As such an inorganic binder, an inorganic binder including a metal oxide as a main component is preferred. Preferred examples thereof include an inorganic binder including as a main component a metal oxide obtained by a sol-gel method from a metal alkoxide represented by the general formula M(OR)n (wherein M represents a metal element, R represents an alkyl group, and n denotes the oxidation number of the metal element M).

Examples of the metal alkoxide include silicon alkoxide, titanium alkoxide, and aluminum alkoxide. Of these, silicon alkoxide is preferred (therefore, as the inorganic binder, an inorganic binder having silicon oxide as a main component is preferred). These metal alkoxides may be used alone, or a plurality may be mixed together.

Examples of the silicon alkoxide include tetraalkoxysilanes having 1 to 4 alkoxy groups which may have the same or different number of carbons, such as tetramethoxysilane, tetraethoxysilane, tetraisopropoxysilane, tetrabutoxysilane, dimethoxydibutoxysilane, and dimethoxydiisopropoxysilane.

Examples of the aluminum alkoxide include tetraalkoxyaluminums having 1 to 4 alkoxy groups which may have the same or different number of carbons, such as tetramethoxyaluminum, tetraethoxyaluminum, tetraisopropoxyaluminum, tetrabutoxyaluminum, dimethoxydibutoxyaluminum, and dimethoxydiisopropoxyaluminum.

Examples of the titanium alkoxide include tetraalkoxytitaniums having 1 to 4 alkoxy groups which may have the same or different number of carbons, such as tetramethoxytitanium, tetraethoxytitanium, tetraisopropoxytitanium, tetrabutoxytitanium, dimethoxydibutoxytitanium, and dimethoxydiisopropoxytitanium.

However, the metal alkoxide is not limited to the above-described three kinds of alkoxide. If a metal alkoxide is used, the inorganic filler (I) and an inorganic filler (II) included in the microporous membrane can be bound, and an inorganic filler layer which is stable for a long duration can be formed.

In the present embodiment, from the perspectives of increasing the binding properties of the inorganic filler (I) and the inorganic binder, and increasing wear resistance (decreasing surface damage when used as a separator), it is preferred that a metal oxide is used as the main component for the inorganic filler (I). Further, from the same perspectives as the above-mentioned, it is preferred that an inorganic binder including a metal oxide as a main component is used as the inorganic binder. In addition, from the same perspectives as the above-mentioned, it is preferred that the metal component of the inorganic filler (I) (i.e., the metal component of the metal oxide) and the metal component of the inorganic binder (i.e., the metal component of the metal oxide) are the same.

The ratio of the binder based on the total amount of the inorganic filler (I) and the binder is preferably 0.1 mass % or more, more preferably 1 mass % or more, and still more preferably 3 mass % or more. As an upper limit, the ratio of binder is preferably 30 mass % or less, more preferably 20 mass % or less, still more preferably 15 mass % or less, and especially preferably 10 mass % or less.

This ratio is preferably set to 0.1 mass % or more because it becomes more different for the inorganic filler (I) to separate, the inorganic porous layer is stably maintained for a long duration, and a low bromine permeability is realized for a long duration. On the other hand, this ratio is preferably set to 30 mass % or less from the perspective of obtaining a high ion permeability.

The thickness of the inorganic porous layer (inorganic porous layer thickness) in the present embodiment is, to obtain a low bromine permeability, preferably 0.1 μm or more, more preferably 1 μm or more, even more preferably 2 μm or more, and especially preferably 5 μm or more. Further, to obtain a high ion permeability, the thickness is preferably 50 μm or less, more preferably 30 μm or less, and even more preferably 20 μm or less.

### Polyolefin Microporous Membrane

The polyolefin microporous membrane serving as the substrate membrane of the inorganic porous layer is formed using a polyolefin resin (polyolefin) as a main component. From the perspectives of the mechanical strength, moldability, and cost of the obtained separator, this polyolefin resin is preferably formed from a polyethylene resin, which can be classified into homopolymers and copolymers of high-density polyethylene, low-density polyethylene, linear low-density polyethylene and the like, a polypropylene resin, and mixtures thereof.

Further, if a polyethylene resin is used as the polyolefin resin, from the perspective of increasing the mechanical strength of the obtained separator, it is preferred to use a polyethylene resin having a density of 0.9 g/cm³ or more, and more preferred to use a polyethylene resin having a density of 0.93 g/cm³ or more. From the perspective of increasing moldability, it is preferred to use a polyethylene resin having a density of 0.99 g/cm³ or less, and more preferred to use a polyethylene resin having a density of 0.98 g/cm³ or less.

Examples of polypropylene resins include a propylene homopolymer, an ethylene-propylene random copolymer, and an ethylene-propylene block copolymer. Here, the ethylene content in the polypropylene resin is preferably 1 mole % or less. More preferably, the polypropylene is a propylene homopolymer.

It is preferred that the polyolefin resin includes ultrahigh molecular weight polyethylene having an intrinsic viscosity of 7 dl/g or more. The ratio of this ultrahigh molecular weight polyethylene in the polyolefin resin is, from the perspective of further increasing mechanical strength, preferably 5 mass % or more, more preferably 10 mass % or more, and still more preferably 15 mass % or more. On the other hand, from the perspective of increasing moldability, as an upper limit, this ratio is preferably 90 mass % or less, more preferably 85 mass % or less, and still more preferably 80 mass % or less.

Further, polyethylene polymerized by a two-stage polymerization method may also be used as the ultrahigh molecular weight polyethylene. As a method using such ultrahigh molecular weight polyethylene, a method in which it is mixed into another polyolefin for forming the polyolefin resin is typical.

To obtain high mechanical strength and a low bromine permeability, it is preferred that the polyolefin microporous membrane includes an inorganic filler (II). As this inorganic filler (II), the same inorganic filler as the above-described inorganic filler (I) may be used. Among those, from the perspectives of realizing high dispersibility and moldability, it is preferred to use silicon oxide (silica) as the main component. Further, to improve the impregnation properties of the electrolyte, it is preferred to use a hydrophilic inorganic filler.

In addition, as the inorganic filler (II), from the perspective of further increasing the binding properties between the polyolefin microporous membrane and the inorganic porous layer, it is preferred to use, as the above-described inorganic binder, an inorganic binder including a metal oxide as the main component, and a metal oxide having the same metal component as the metal component of the inorganic binder.

The ratio of the inorganic filler (II) in the polyolefin microporous membrane is, from the perspective of increasing mechanical strength, preferably 1 mass % or more, more preferably 5 mass % or more, still more preferably 10 mass % or more, and especially preferably 20 mass % or more. Further, from the perspective of increasing the ion permeability, this ratio is preferably 99 mass % or less, more preferably 95 mass % or less, still more preferably 90 mass % or less, and especially preferably 80 mass % or less.

To the extent that the purpose of the present embodiment is not harmed, the polyolefin microporous membrane may optionally include an additive such as an antioxidant, a UV absorber, a lubricant, an anti-blocking agent, a colorant, a flame retardant and the like.

To increase mechanical strength, it is preferred that the polyolefin microporous membrane has an intrinsic viscosity [ρ] of preferably 1 dl/g or more, more preferably 2 dl/g or more, even more preferably 3 dl/g or more, and especially preferably 3.5 dl/g or more. Further, to increase the moldability of the polyolefin microporous membrane, this intrinsic viscosity [ρ] is preferably 15 dl/g or less, more preferably 12 dl/g or less, even more preferably 11 dl/g or less, especially preferably 10 dl/g or less, and extremely preferably 9 dl/g or less.

To obtain a high ion permeability, the polyolefin microporous membrane has a porosity of preferably 30% or more, more preferably 40% or more, and still more preferably 50% or more. In addition, to obtain a low bromine permeability, this porosity is preferably 80% or less, more preferably 70% or less, and still more preferably 60% or less.

To obtain a low bromine permeability, the polyolefin microporous membrane has an air permeability of preferably 1 sec/100 cc/μm or more, more preferably 3 sec/100 cc/μm or more, and still more preferably 5 sec/100 cc/μm or more. Further, to obtain a high ion permeability, this air permeability is preferably 50 sec/100 cc/μm or less, more preferably 30 sec/100 cc/μm or less, and still more preferably 10 sec/100 cc/μm or less.

The ratio (Si/C ratio) between the number of silicon atoms and the number of carbon atoms present on the surface of the polyolefin microporous membrane, namely, the ratio between the number of silicon atoms and the number of carbon atoms present on the face in contact with the inorganic porous layer of the polyolefin microporous membrane, is, to increase the binding properties with the inorganic binder and to obtain high wear properties, preferably 0.005 or more, more preferably 0.01 or more, and still more preferably 0.015 or more. Further, to obtain a high crack resistance, this Si/C ratio is preferably 0.45 or less, more preferably 0.4 or less, and still more preferably 0.3 or less. The Si/C ratio can be appropriately adjusted by methods such as using silicon oxide as the polyolefin microporous membrane raw material and adjusting the blended amount of the silicon oxide.

Another example of a method for adjusting this parameter is adjusting the concentrations of the polyolefin resin and the inorganic filler (II).

To obtain a low bromine permeability, the polyolefin microporous membrane has a bromine diffusion coefficient of preferably 10×10⁻⁹ mol/cm²/sec or less, and more preferably 8×10⁻⁹ mol/cm²/sec or less. The lower limit for this bromine diffusion coefficient is not especially limited, and may be 0 mol/cm²/sec, for example.

An example of a method for adjusting this parameter is adjusting the concentrations of the polyolefin resin, inorganic filler (II), and plasticizer, and adjusting the intrinsic viscosity of the used polyolefin.

To obtain high ion permeability, the polyolefin microporous membrane has an electrical resistance of preferably 0.005 ω·100 cm²/sheet or less, more preferably 0.004 ω·100 cm²/sheet or less, still more preferably 0.003 ω·100 cm² or less, and especially preferably 0.002 ω·100 cm²/sheet or less. The lower limit for the electrical resistance is not especially limited, and may be 0 ω·100 cm²/sheet, for example.

Further, an example of a method for adjusting this parameter is adjusting the concentrations of the polyolefin resin, inorganic filler (II), and plasticizer.

From the perspectives of mechanical strength and bromine diffusion, the thickness of the polyolefin microporous membrane in the present embodiment is preferably 50 μm or more, more preferably 100 μm or more, and still more preferably 200 μm or more. Further, from the perspective of ion permeability, this thickness is preferably 2,000 μm or less, more preferably 1,000 μm or less, and still more preferably 800 μm or less.

Unless otherwise noted, the respective parameters in the present specification are values as measured based on the measurement method described in the following Examples.

### Separator For Metal Halide Battery

To obtain a low bromine permeability and a high crack resistance, the separator for a metal halide battery (in this embodiment, sometimes simply referred to as “separator”) according to the present embodiment has a membrane thickness of preferably 100 μm or more, more preferably 200 μm or more, still more preferably 300 μm or more, and especially preferably 400 μm or more. Further, to obtain a high ion permeability, this membrane thickness is preferably 2000 μm or less, more preferably 1500 μm or less, still more preferably 1000 μm or less, and even still more preferably 800 μm or less.

To obtain a low bromine permeability, the separator has an air permeability of preferably 1 sec/100 cc/μm or more, more preferably 3 sec/100 cc/μm or more, and still more preferably 5 sec/100 cc/μm or more. Further, to obtain a high ion permeability, this air permeability is preferably 50 sec/100 cc/μm or less, more preferably 30 sec/100 cc/μm, and still more preferably 10 sec/100 cc/μm or less.

To obtain a low bromine permeability, the separator has a bromine diffusion coefficient (initial bromine diffusion coefficient) of preferably 3.5×10⁻⁹ mol/cm²/sec or less, more preferably 3.0×10⁻⁹ mol/cm²/sec or less, and still more preferably 2.5×10⁻⁹ mol/cm²/sec or less. The lower limit for this bromine diffusion coefficient is not especially limited, and may be 0 mol/cm²/sec, for example.

To obtain a long life battery, the separator has a bromine diffusion coefficient after 240 hours of preferably less than 4.2×10⁻⁹ mol/cm²/sec, more preferably 4.0×10⁻⁹ mol/cm²/sec or less, still more preferably 3.5×10⁻⁹ mol/cm²/sec or less, and especially preferably 3.0×10⁻⁹ mol/cm²/sec or less. The lower limit for this bromine diffusion coefficient after 240 hours is not especially limited, and may be 0 mol/cm²/sec, for example.

Further, to obtain an even longer life battery, the separator has a bromine diffusion coefficient after 720 hours of preferably 4.0×10⁻⁹ mol/cm²/sec or less, more preferably 3.9×10⁻⁹ mol/cm²/sec or less, still more preferably 3.5×10⁻⁹ mol/cm²/sec or less, and especially preferably 3×10⁻⁹ mol/cm²/sec or less. The lower limit for this bromine diffusion coefficient after 720 hours is not especially limited, and may be 0 mol/cm²/sec, for example.

Examples of methods for adjusting these parameters (initial, after 240 hours, and after 720 hours bromine diffusion coefficient) include adjusting the inorganic filler (I) particle size, the inorganic binder concentration, the inorganic binder type, and the inorganic filler layer thickness.

To obtain high wear properties, the separator has a pencil hardness of preferably HB or greater, more preferably H or greater, still more preferably 3H or greater, especially preferably 5H or greater, and extremely preferably 6H or greater.

Examples of methods for adjusting this parameter include adjusting the inorganic filler (I) particle size, the inorganic binder concentration, and the inorganic binder type.

To obtain a high crack resistance, the separator has a tensile breaking strength of preferably 2.5 MPa or more, more preferably 3 MPa or more, and still more preferably 3.5 MPa or more. The upper limit of the tensile breaking strength is not especially limited, and may be 50 MPa, for example.

Further, to obtain a high crack resistance, the separator has a tensile breaking elongation of preferably 50% or more, more preferably 100% or more, and still more preferably 150% or more. The upper limit of the tensile breaking elongation is not especially limited, and may be 1,000%, for example.

To maintain a low bromine permeability for a long duration, the separator has a crack resistance of preferably 10% or less, more preferably 5% or less, still more preferably 3% or less, and even still more preferably 1% or less. The lower limit of the crack resistance is not especially limited, and may be 0%, for example.

To obtain a high ion permeability, the separator has a wettability (evaluated from the inorganic porous layer side) of preferably 100 sec/10 μL or less, more preferably 60 sec/10 μL or less, still more preferably 30 sec/10 μL or less, and especially preferably 20 sec/10 μL or less. The lower limit of the wettability is not especially limited, and may be 0 sec/10 μL, for example.

When the separator is mounted in a zinc-bromine battery, the separator preferably has a Coulombic efficiency of 70% or more, more preferably 75% or more, and still more preferably 80% or more. The upper limit of the Coulombic efficiency is not especially limited, and may be 100%, for example.

To obtain high ion permeability, the separator has an electrical resistance of preferably 0.005 ω·100 cm²/sheet or less, more preferably 0.004 ω·100 cm²/sheet or less, still more preferably 0.003 ω·100 cm²/sheet or less, and especially preferably 0.002 ω·100 cm²/sheet or less. The lower limit for the electrical resistance is not especially limited, and may be 0 ω·100 cm²/sheet, for example.

Examples of methods for adjusting these parameters (tensile breaking strength, tensile breaking elongation, crack resistance, wettability, and Coulombic efficiency) include adjusting the inorganic filler (I) particle size, the inorganic binder concentration, the inorganic binder type, and the inorganic filler layer thickness.

The respective parameters of the above-described separator are values measured based on a measurement method described in the following Examples.

### Process for Producing Separator for Metal Halide Battery

The separator for a metal halide battery according to the present embodiment can be formed by, for example, carrying out the following steps of: producing the substrate membrane and forming the inorganic porous layer.

### (1) Step of Producing Substrate Membrane (Polyolefin Microporous Membrane)

First, to produce a substrate membrane, a raw material mixture is produced from the above-described polyolefin resin, a plasticizer, and optionally the above-described inorganic filler (II).

The polyolefin resin serving as a raw material may be one kind of polyolefin resin or may be a composition formed from two or more kinds of polyolefin resin.

Here, to obtain a high mechanical strength, the ratio of the polyolefin resin in the raw material mixture is, based on the total mass of the raw material mixture, 5 mass % or more, preferably 10 mass % or more, more preferably 15 mass % or more, and especially preferably 20 mass % or more. On the other hand, to obtain a high ion permeability, based on the total weight of the raw material mixture, this ratio is 60 mass % or less, preferably 50 mass % or less, more preferably 40 mass % or less, and especially preferably 30 mass % or less.

To obtain a low bromine permeability, the ratio of the inorganic filler (II) in the raw material mixture is, based on the total mass of the raw material mixture, 5 mass % or more, preferably 10 mass % or more, more preferably 15 mass % or more, and especially preferably 20 mass % or more. On the other hand, to obtain a high moldability and mechanical strength, based on the total mass of the raw material mixture, this ratio is 60 mass % or less, preferably 50 mass % or less, more preferably 40 mass % or less, and especially preferably 30 mass % or less.

It is preferred that the plasticizer is a liquid during melt molding, and is inactive. Examples thereof include phthalates or phosphates such as diethyl phthalate (DEP), dibutyl phthalate (DBP), dioctyl phthalate (DnOP), and bis(2-ethylhexyl) phthalate (DOP), and organics such as liquid paraffin. Of these, to obtain a high ion permeability. DBP, DnOP, DOP and a mixture thereof is preferred.

To obtain a high ion permeability, the ratio of the plasticizer in the raw material mixture is, based on the total mass of the raw material mixture, 30 mass % or more, preferably 35 mass % or more, more preferably 40 mass % or more, and especially preferably 45 mass % or more. On the other hand, to obtain a high moldability and mechanical strength, based on the total mass of the raw material mixture, this ratio is 80 mass % or less, preferably 75 mass % or less, more preferably 70 mass % or less, especially preferably 65 mass % or less, and extremely preferably 60 mass % or less.

Mixing of the polyolefin resin, inorganic filler (II), and plasticizer may be carried out by an ordinary mixing method using a blender such as a Henschel mixer, a V-blender, a ploughshare mixer, a ribbon blender and the like.

The raw material mixture is formed into a sheet by kneading with a melt kneading apparatus such as an extruder or a kneader, and performing extrusion molding using a T die.

The plasticizer is solvent-extracted from this sheet-like molded body, and the resultant product is dried to obtain a polyolefin microporous membrane which will serve as the substrate membrane.

Examples of the solvent used in the plasticizer extraction include an organic solvent such as methanol, ethanol, methyl ethyl ketone, and acetone, and halogenated hydrocarbons such as methylene chloride.

Further, to the extent that the advantages of the present embodiment are not harmed, the sheet-like molded body may be stretched before, after, or before and after extracting the plasticizer. In addition, the substrate membrane may also be subjected to a post-treatment. Examples of post-treatments include a hydrophilic treatment by a surfactant or the like, and a crosslinking treatment by ionizing radiation.

### (2) Step of Forming Inorganic Porous Layer

The inorganic porous layer can be produced by the following methods, for example.

(A) Feeding the raw materials of the substrate membrane into an extruder, feeding the raw materials of the inorganic porous layer (e.g., the inorganic filler (I), binder (preferably an inorganic binder) or raw materials thereof, and optionally a plasticizer) into another extruder, unifying the raw materials with one die and molding (coextruding) them into a sheet, and then extracting the plasticizer in the inorganic porous layer.
(B) Dissolving or dispersing the inorganic filler (I) and the binder or raw materials thereof in a solvent to prepare a solution containing the inorganic filler, then coating the solution on at least one face of the substrate membrane, and removing the solvent.

As the plasticizer used in method (A), the same plasticizer as that used in the step of producing the substrate membrane may be used.

Here, to obtain a high ion permeability and a low bromine permeability, it is preferred to form the inorganic porous layer by a coating method (method (B)). Method (B) will now be described in more detail.

The solvent used in method (B) is preferably a solvent which can uniformly and stably dissolve or disperse the inorganic filler (I) and the binder or raw materials thereof. Examples of such a solvent include N-methylpyrrolidone, N,N-dimethylformamide, N,N-dimethylacetamide, water, ethanol, toluene, hot xylene, and hexane. These solvents may be used alone, or a plurality may be used together.

Further, to stabilize the solution containing the inorganic filler, or to improve the coatability onto the substrate membrane, various additives may be added, a surfactant or other such dispersant, a thickener, a wetting agent, a defoaming agent, and a pH regulator including an acid or an alkali and the like. Although it is preferred to remove these additives during solvent removal and plasticizer extraction, the additives may be allowed to remain in the battery if they are electrochemically stable in the usage range of a metal halide battery (especially, a zinc-bromine battery), do not hinder the battery reactions, and are stable up to about 200° C.

The method for dissolving or dispersing the inorganic filler (I) and the binder in the solvent is not especially limited, as long as the required solution or dispersion properties can be realized during the below-described coating step. Examples include mechanical stirring by a ball mill, a bead mill, a planetary mill, a vibrating ball mill, a sand mill, a colloid mill, an attritor, a roll mill, a high-speed impeller disperser, a disperser, a homogenizer, a high-speed impact mill, an ultrasonic wave disperser, a stirring blade and the like.

The method for coating the solution containing the inorganic filler on the substrate membrane is not especially limited, as long as the required membrane thickness and coating area can be realized. Examples include gravure coating, small-diameter gravure coating, reverse roll coating, transfer roll coating, kiss coating, dip coating, knife coating, air doctor coating, blade coating, rod coating, squeeze coating, cast coating, die coating, screen printing, and spray coating. Further, based on the application, the solution containing the inorganic filler may be coated on only one face of the substrate membrane, or on both faces of the substrate membrane.

In addition, prior to coating, it is preferred to actively subject the surface of the substrate membrane to a surface treatment, because this makes it easier to uniformly coat the solution containing the inorganic filler and improves the adhesion between the coated layer and the surface of the substrate membrane. The surface treatment method is not especially limited, as long as it does not substantially harm the porous structure of the substrate membrane. Examples include a corona discharge treatment, mechanical surface roughening, a solvent treatment, an acid treatment, and ultraviolet oxidation.

In method (B), the inorganic porous layer including the inorganic filler (I) and the binder is formed by removing the solvent from the solution containing the inorganic filler coated on the substrate membrane. The method for removing the solvent is not especially limited, as long as it does not have an adverse impact on the substrate membrane. Examples include drying the substrate membrane at a temperature equal to or below the melting point of the substrate membrane while it is fixed, and drying at a low temperature under reduced pressure. Another example is, when a binder is included in the solution containing the inorganic filler, to dip in a poor solvent for the resin binder, and when the resin binder solidifies, simultaneously extract the solvent.

### Metal Halide Battery

A metal halide battery can be formed by combining the thus-obtained separator for a metal halide battery, a positive electrode, a negative electrode, and an electrolyte. Apart from using the above-described separator for a metal halide battery as a separator, this metal halide battery may have the same structure as a conventional battery. When mounting the separator for a metal halide battery in the battery, from the perspective of thoroughly suppressing self discharge, it is preferred that the face of the inorganic porous layer is made to face the positive electrode electrolyte.

The separator for a metal halide battery according to the present embodiment can achieve both a high ion permeability and a low bromine permeability. Therefore, when this separator is used in a metal halide battery, a high Coulombic efficiency can be obtained, so that the battery efficiency can be increased. Consequently, this separator is especially suitable as a zinc-bromine battery separator. In addition, this separator can also sufficiently combine a high crack resistance.

### EXAMPLES

Next, the present embodiment will be specifically described based on the following Examples and Comparative Examples. However, the present invention is not limited to the following Examples, as long as it does not go beyond the gist thereof. The physical properties in the Examples were measured according to the following methods.

### (1) Membrane Thickness and Inorganic Porous Layer Thickness (μm)

The membrane thickness of the substrate membrane and the separator were measured at an atmosphere temperature of 23±2° C. using a thickness micrometer (Type KBN; terminal diameter 5 mm; measurement pressure, 62.47 kPa) manufactured by Toyo Seiki Seisaku-sho Ltd. The difference between the measured values was taken as the inorganic porous layer thickness.

(2) Air Permeability (sec/100 mL)

The air permeability of the substrate membrane and the separator was measured with a Gurley densometer (G-B2 (trademark), Toyo Seiki Seisaku-sho, Ltd.) according to JIS P 8117. The inner cylinder weighed 567 g, and the time taken for 100 mL of air to pass through an area of 645 mm² having a diameter of 28.6 mm was measured.

(3) Electric Resistance (ω·100 cm²/sheet)

Electric resistance of the substrate membrane and the separator were evaluated according to JIS C-2313.

### (4) Bromine Diffusion Coefficient

### (4-1) Initial

The bromine permeability of the substrate membrane and the separator were evaluated by measuring the bromine diffusion coefficient.

The bromine diffusion coefficients of the substrate membrane and the separator were measured using the following cell for measurement of bromine diffusion coefficient. In the cell, an electrolyte formed by adding 0.2 M Br₂ to 3 M ZnBr₂ was used as the positive electrode electrolyte, and 3 M ZnBr₂ was used as the negative electrode electrolyte.

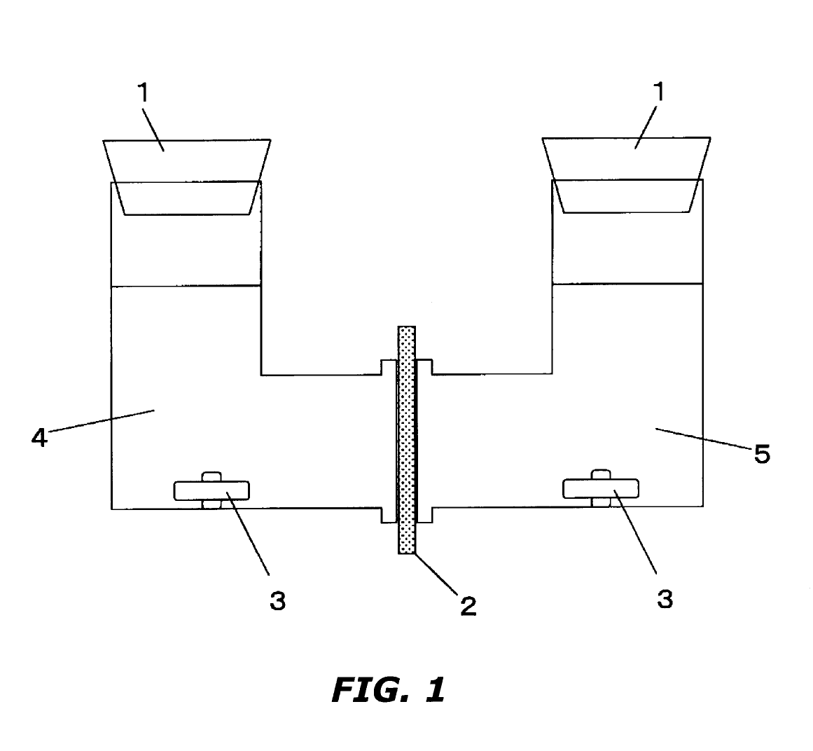

FIG. 1 illustrates a schematic diagram of a cell for measurement of bromine diffusion coefficient. The cell for the measurement of the bromine diffusion coefficient is configured from a positive electrode cell 4 including a stirrer chip 3, in which one end is blocked by a silicon rubber stopper 1 and the other end is blocked by a separator 2, and a negative electrode cell 5 including a stirrer chip 3, in which one end is blocked by a silicon rubber stopper 1 and the other end is blocked by the separator 2. Here, the positive electrode cell 4 and the negative electrode cell 5 are arranged so as to be in communication with each other via the separator 2. Further, the face on the inorganic porous layer side is arranged facing the positive electrode cell 4. The above-described positive electrode electrolyte is filled in the positive electrode cell 4, and the above-described negative electrode electrolyte is filled in the negative electrode cell 5.

Both solutions in the positive electrode cell 4 and the negative electrode cell 5 were stirred for 4 hours by the stirrers, and then the negative electrode electrolyte included in the negative electrode cell 5 was extracted. The amount of bromine in the stirred negative electrode electrolyte was measured, and the bromine diffusion coefficient was determined based on the following equation.

Bromine diffusion coefficient (mol/cm^{2/sec)=}M/(S×T)

M: Bromine amount in the negative electrode electrolyte
S: Surface area (cm²) of one of the faces of the microporous membrane (the substrate membrane and the separator) in contact with the electrolyte
T: Measurement time (sec)

### (4-2) After 240 Hours, After 720 Hours, and Percentage Change

The sustained effects of the bromine permeability of the separator were evaluated by measuring the change over time (240 hours and 720 hours) in the bromine diffusion coefficient of the separator.

When measuring the change over time in the bromine diffusion coefficient of the separator, first, a separator fixed to a stainless steel frame was placed into a 3 M ZnBr₂ electrolyte, and the electrolyte was stirred at 1000 rpm. After continuing this for 240 hours and 720 hours, the bromine diffusion coefficients after 240 hours and after 720 hours of the separator were measured by the same method as in (4-1). The bromine diffusion coefficients after 240 hours and after 720 hours were divided by the initial bromine diffusion coefficient, and the calculated value was multiplied by 100 to give the percentage change.

(5) Wettability (sec/10 μL)

When measuring the wettability of the separator, first, 10 μL of distilled water was measured using a micropipette, and added dropwise onto the separator surface (inorganic porous layer surface). The time taken until the water drops completely permeated the separator was measured with a stopwatch. Measurement was carried out 3 times, and the average value thereof was taken as the separator wettability.

### (6) Pencil Hardness

The wear properties of the separator were evaluated by a pencil hardness test on the separator. This test is a test method for evaluating, according to JIS K 5600-5-4, based on the hardness (pencil hardness) of the hardest pencil which did not cause a defect, such as a scratch, when a pencil lead was moved at a predetermined speed and distance over the inorganic filler layer face. “Uni” (trade name) pencils manufactured by Mitsubishi Pencil Co., Ltd., from 6B (soft) to 6H (hard) were used.

### (7) Initial Coulombic Efficiency (%) and Coulomb Maintenance (%)

Coulomb maintenance (maintainability of the initial Coulombic efficiency) of a zinc-bromine battery was measured as follows.

Coulombic efficiency is the ratio of the discharged amount of electricity (current l₂×discharge time h₂) to the charged amount of electricity (current l₁×discharge time h₁). Coulombic efficiency is derived from the following equation.

Coulombic efficiency (%)=100×(l₂×h₂)/(l₁×hᵢ)

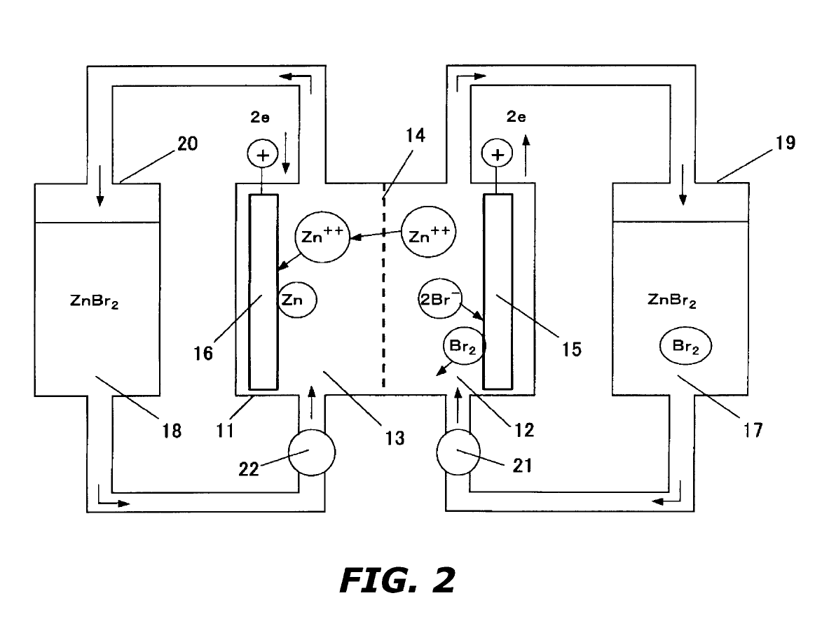

FIG. 2 illustrates a configuration diagram of a simple cell of a zinc-bromine secondary battery used for Coulombic efficiency measurement.

This simple cell includes a single cell 11 having a positive electrode chamber 12 and a negative electrode chamber 13 separated by a separator 14. A positive electrode 15 is arranged in the positive electrode chamber 12, and a negative electrode 16 is arranged in the negative electrode chamber 13. The positive electrode chamber 12 is in communication with a storage tank 19 for a positive electrode solution storing a positive electrode electrolyte 17 via a feeding line and a pump 21. Further, the positive electrode chamber 12 is configured so that the positive electrode electrolyte 17 moves back and forth between the positive electrode chamber 12 and the storage tank 19. Similarly, the negative electrode chamber 13 is in communication with a storage tank 20 for a negative electrode solution storing a negative electrode electrolyte 18 via a feeding line and a pump 22. Further, the negative electrode chamber 13 is configured so that the negative electrode electrolyte 18 moves back and forth between the negative electrode chamber 13 and the storage tank 20 by the pump 22.

For the measurement of Coulombic efficiency, a simple cell of a zinc-bromine secondary battery like that illustrated in FIG. 2 was used. A platinum electrode having an electrode surface area of 400 cm² was used as the electrode, and a mixed solution of a 3 mol/L zinc bromide solution, a 4 mol/L ammonium chloride solution, and a 1 mol/L methyl ethyl pyrrolidinium bromide (MEPBr) solution was used as the electrolyte. Coulombic efficiency was measured under conditions of a charge/discharge current density of 20 mA/cm², a membrane-electrode direction of 1 mm, an electrolyte flow rate of 100 mL/min, a positive and negative chamber volume of 500 mL, a charging time of 4 hours, a cutoff voltage of 0.5 volts, and a liquid temperature during operation of 25° C. or more.

The initial Coulombic efficiency refers to the Coulombic efficiency for the first charge/discharge. Coulomb maintenance is expressed as a percentage of the 300th charge/discharge Coulombic efficiency over the first charge/discharge Coulombic efficiency.

### (8) Dispersion Average Particle Size (μm)

The Dispersion average particle size was measured under the following conditions using a laser diffraction scattering type particle size analyzer (SALD-3000) manufactured by Shimadzu Corporation. The median diameter determined from this measurement was taken as the dispersion average particle size.

Measurement solvent: Industrial alcohol
Ekinen F-8 (trade name), manufactured by Japan Alcohol Trading Co., Ltd.
Composition: Ethanol 86.4%, methanol 7.3%, water content 6.3%
Dispersion conditions: While stirring at 200 rpm, irradiate 40 W ultrasonic waves for 10 minutes, and then measure
Refraction setting values: Silica 1.40, alumina 1.76, titania 2.52
Measurement temperature: 25° C.

### (9) M Value (Vol %)

0.2 g of inorganic fine particles (inorganic filler) as measurement target was weighed and added to 50 mL of distilled water filled in a beaker having a 250 mL volume. While slowing stirring, the inorganic particles were entirely wetted with methanol from a burette whose tip was dipped in the solution. Specifically, the solution was slowly added dropwise into aqueous methanol until settling out. The amount of methanol required to completely wet the inorganic particles was taken as “a” mL, and the M value was calculated from the following equation.

M value=100×a/(a+50)

### (10) Porosity (%)

### (i) Method for Analyzing Polyolefin/Inorganic Filler (Inorganic Filler II) Composition

The composition ratio of the inorganic filler in the substrate membrane was calculated using the thermogravimetric analyzer TG/DTA 220 (trademark) manufactured by Seiko Instruments Inc., from the initially measured weight under an air flow for about 10 mg of a sample and the weight measured after leaving for 60 minutes at 550° C. The difference between these weights was taken as the mass of the inorganic filler for calculating the above-described composition ratio.

### (ii) Porosity Calculation

Porosity (%)=(1−(X/(Y×Z)))×100

X: Membrane weight (g/m²)
Y: Membrane specific gravity (g/cm³)

Porosity was calculated using the polyolefin density, the inorganic filler density, and the composition ratio determined from the above method for analyzing the polyolefin/inorganic filler composition.

Z: Membrane thickness (μm)

### (11) Intrinsic Viscosity [ρ]

Intrinsic viscosity was measured according to the following steps.

### (i) Producing Polyolefin Simple Membrane

A separator was dipped in alcohol, and the air was generally extracted therefrom. Then, the separator was immersed in 80° C. aqueous 20% caustic soda for 1 day and night. The separator was washed with 60° C. hot water, and then washed with flowing water for 1 day and night. The resultant membrane was dried for 1 day and night with a dryer set to 40° C. to obtain a simple membrane. The composition of the simple membrane was calculated using the thermogravimetric analyzer TG/DTA 220 (trademark) manufactured by Seiko Instruments Inc., from the initially measured weight under an air flow for about 10 mg of sample and the weight measured after leaving for 60 minutes at 550° C. It obtained result confirmed that the remaining inorganic filler (silica) amount was 1 mass % or less.

### (ii) Intrinsic Viscosity [ρ]

The intrinsic viscosity [ρ] of the raw material polyolefin and substrate membrane were obtained by determining intrinsic viscosity [ρ] at 135° C. in decalin solution based on ASTMD 4020. To measure the substrate membrane, the simple membrane produced in (i) was used.

### (12) Mechanical Properties (Tensile Breaking Strength and Tensile Breaking Elongation)

The tensile breaking strength (MPa) of the separator in the long direction (MD) and the width direction (TD) of a sample (size: width 10 mm×length 100 mm) were measured based on JIS K 7127 using a tensile tester, the autograph AG-A model (trademark) manufactured by Shimadzu Corporation. The sample chuck interval was 50 mm. The strength at fracturing was determined by dividing by the pre-test sample cross-sectional area.

Tensile breaking elongation (%) was determined by dividing the amount of elongation (mm) until fracture by the chuck interval distance (50 mm), and multiplying the result by 100.

The measurements were carried out at a temperature of 23±2° C., a chuck pressure of 0.30 MPa, and a tension rate of 200 mm/min.

### (13) Si/C Ratio

The ratio (Si/C ratio) between the number of silicon atoms and the number of carbon atoms present on the surface of the substrate membrane was measured by the following method.

A sample was cut into a square having sides of about 10×10 mm. The sample was dipped in methylene chloride overnight (17 hours), then removed, rinsed with new methylene chloride, and dried. Then, the sample was fixed by a clip to an XPS (X-ray photoelectron spectroscopy) sample bench. After the sub-chamber was preliminarily evacuated, the sample was introduced into the apparatus. The C (1s) and Si (2p) electron intensities were measured to determine the Si/C ratio.

Apparatus: ESCA 5400 (trade name), manufactured by ULVAC PHI, Inc.
X-ray source: Mg Ka (no monochrome, conventional Mg Ka)
Measurement peak: Narrow Scan; C 1s, Si 2p
Pass energy: Survey Scan; 178.9 eV, Narrow Scan; 35.75 eV
Ar ion sputter: Degree of vacuum 5.0×10⁻⁵ Torr, power 2 kV, 25 mA, sputter time 1 min

### Production Example 1

A mixture was formed by mixing with a super mixer 8 mass % of ultrahigh molecular weight polyethylene having a [ρ] of 11.5 dl/g and a density of 0.94 g/cm³, mass % of high-density polyethylene having a [ρ] of 2.8 dl/g and a density of 0.96 g/cm³, 25 mass % of a fine powder of hydrophilic wet-process silica (inorganic filler A; details concerning the various inorganic fillers are collectively shown in Table 1) having a dispersion average particle size of 2.00 μm produced by a wet process, and 52 mass % of bis(2-ethylhexyl)phthalate (DOP). The mixture was molded and extruded at a T-die discharge resin temperature of 220° C. from a 30 mm diameter twin-screw extruder having a 450 mm wide T die. During this process, to achieve dimensional stability, melt extrusion was carried out while keeping a gear pump fore pressure constant via a gear pump. The resin mixture extruded from the T-die was molded into a sheet having a membrane thickness of 600 μm by rolling with a calender roll having a temperature adjusted to 140° C.

The molded sheet was dipped for 1 hour in methylene chloride to extract the bis(2-ethylhexyl)phthalate (DOP), and the resultant product was then dried. The physical properties of the thus-obtained substrate membrane 1 are shown in Table 2.

### Production Example 2

A resin mixture extruded from the T-die in the same manner as in Production Example 1 was molded into a sheet having a membrane thickness of 400 μm. After extracting the DOP in the same manner as in Production Example 1, the resultant product was dried. The physical properties of the thus-obtained substrate membrane 2 are shown in Table 2.

### Production Example 3

Substrate membrane 3 was obtained in the same manner as in Production Example 1, by mixing with a super mixer 10 mass % of ultrahigh molecular weight polyethylene having a [ρ] of 11.5 dl/g and a density of 0.94 g/cm³, 25 mass % of high-density polyethylene having a [ρ] of 2.8 dl/g and a density of 0.96 g/cm³, 10 mass % of silica having a primary particle size of 20 nm and a dispersion average particle size of 7 μm, and 55 mass % of bis(2-ethylhexyl)phthalate (DOP). The physical properties of the thus-obtained substrate membrane 3 are shown in Table 2.

### Production Example 4

The substrate membrane 4 was obtained in the same manner as in Production Example 1 by mixing with a super mixer 1 mass % of ultrahigh molecular weight polyethylene having a [ρ] of 15 dl/g and a density of 0.94 g/cm³, 22 mass % of high-density polyethylene having a [ρ] of 2.8 dl/g and a density of 0.96 g/cm³, 23 mass % of silica having a primary particle size of 20 nm and a dispersion average particle size of 7 μM, and 54 mass % of bis(2-ethylhexyl)phthalate (DOP). The physical properties of the thus-obtained substrate membrane 4 are shown in Table 2.

### Example 1

An inorganic dispersion was produced by adding 20 mass % of a fine powder of hydrophilic silica (inorganic filler B) having a dispersion average particle size of 0.25 μm produced by a dry method to a solution of 20 mass % of ethanol and 60 mass % of distilled water, and then uniformly dispersing the resultant mixture with a homogenizer.

Further, a binder solution was produced by mixing 20 mass % of methyl ethyl silicate 51 (MES 51, trade name) manufactured by Colcoat Co., Ltd., 50 mass % of ethanol, 25 mass % of distilled water, and 5 mass % of 1 mass % aqueous nitric acid, and adjusting the solid content concentration to 10 mass %.

1 g of the binder solution was added to 20 g of the inorganic dispersion to produce a coating solution (solution containing the inorganic filler). The binder concentration based on the inorganic filler at this stage was 5 mass %.

This coating solution was coated on a surface (one face) of the substrate membrane 1 using a gravure coater. Then, the solvent was removed by drying at 60° C. The composition and physical properties of the obtained separator are shown in Tables 3 to 5.

### Example 2

2 g of the binder solution produced in Example 1 was added to 20 g of the inorganic dispersion produced in Example 1 to produce a coating solution. The binder concentration based on the inorganic filler at this stage was 10 mass %.

Using this binder solution, a separator was produced in the same manner as in Example 1. The composition and physical properties of the obtained separator are shown in Tables 3 to 5.

### Example 3

A binder solution was produced by mixing 25 mass % of methyl ethyl silicate 40 (ES 40, trade name) manufactured by Colcoat Co., Ltd., 50 mass % of ethanol, 20 mass % of distilled water, and 5 mass % of 1 mass % aqueous nitric acid, and adjusting the solid content concentration to 10 mass %.

Using this binder solution, a separator was produced in the same manner as in Example 1. The composition and physical properties of the obtained separator are shown in Tables 3 to 5.

### Example 4

A binder solution was produced by mixing 20 mass % of methyl silicate MS 56 (trade name) manufactured by Mitsubishi Chemical Corporation, 50 mass % of ethanol, 25 mass % of distilled water, and 5 mass % of 1 mass % aqueous nitric acid, and adjusting the solid content concentration to 10 mass %.

Using this binder solution, a separator was produced in the same manner as in Example 1. The composition and physical properties of the obtained separator are shown in Tables 3 to 5.

### Example 5

An inorganic dispersion was produced by uniformly dispersing with a homogenizer a mixed solution of 50 mass % of colloidal silica (inorganic filler C), having a solid content concentration of 20 mass % and a dispersion average particle size of 0.01 μm, and 50 mass % of ethanol.

2 g of the binder solution produced in Example 1 was added to 20 g of this inorganic dispersion to produce a coating solution. The binder concentration based on the inorganic filler at this stage was 5 mass %.

This coating solution was coated on a surface of the substrate membrane 1 using a gravure coater. Then, the solvent was removed by drying at 60° C. The composition and physical properties of the obtained separator are shown in Tables 3 to 5.

### Example 6

1 g of the binder solution produced in Example 3 was added to 20 g of the inorganic dispersion produced in Example 5 to produce a coating solution. The binder concentration based on the inorganic filler at this stage was 5 mass %.

This coating solution was coated on a surface of the substrate membrane 1 using a gravure coater. Then, the solvent was removed by drying at 60° C. The composition and physical properties of the obtained separator are shown in Tables 3 to 5.

### Example 7

The coating solution produced in Example 6 was coated on both faces of the substrate membrane 1 to produce a separator having an inorganic porous layer on either side. The composition and physical properties of the obtained separator are shown in Tables 3 to 5.

### Example 8

The substrate membrane 1 was dipped in the coating solution produced in Example 6 for 30 seconds by a dipping method, and then the solvent was removed by drying at 60° C. The composition and physical properties of the obtained separator are shown in Tables 3 to 5.

### Example 9

A separator was produced in the same manner as in Example 1, except that alumina (inorganic filler D) having a dispersion average particle size 0.70 μm was used. The composition and physical properties of the obtained separator are shown in Tables 3 to 5.

### Example 10

A separator was produced in the same manner as in Example 1, except that titania (inorganic filler E) having a dispersion average particle size 0.40 μm was used. The composition and physical properties of the obtained separator are shown in Tables 3 to 5.

### Example 11

A separator was produced in the same manner as in Example 6, except that the substrate membrane 2 was used. The composition and physical properties of the obtained separator are shown in Tables 3 to 5.

### Example 12

A separator was produced in the same manner as in Example 6, except that the substrate membrane 3 was used. The composition and physical properties of the obtained separator are shown in Tables 3 to 5.

### Example 13

An inorganic dispersion was produced by adding 14 mass % of a fine powder of hydrophilic silica (inorganic filler A) having a dispersion average particle size of 2.0 μm produced by a wet process to a solution of 14 mass % of ethanol and 72 mass % of distilled water, and then uniformly dispersing the resultant mixture with a homogenizer. This dispersion was charged with 4 mass % based on the inorganic filler of polyvinyl alcohol (PVA) (resin density 1.28 g/cm³, average degree of polymerization 1,700, degree of saponification 99% or more) as a binder to produce a coating solution.

This coating solution was coated on a surface (one face) of the substrate membrane 1 using a gravure coater. Then, the solvent was removed by drying at 60° C. The composition and physical properties of the obtained separator are shown in Tables 3 to 5.

### Example 14

A separator was produced in the same manner as in Example 13, except that a fine powder of hydrophilic silica (inorganic filler F) having a dispersion average particle size of 0.6 μm produced by a wet process was used. The composition and physical properties of the obtained separator are shown in Tables 3 to 5.

### Example 15

A separator was produced in the same manner as in Example 13, except that a fine powder of hydrophilic silica (inorganic filler B) having a dispersion average particle size of 0.25 μm produced by a dry method was used. The composition and physical properties of the obtained separator are shown in Tables 3 to 5.

### Example 16

A separator was produced in the same manner as in Example 15, except that the substrate membrane 2 produced in Production Example 2 was used. The composition and physical properties of the obtained separator are shown in Tables 3 to 5.

### Example 17

A separator was produced in the same manner as in Example 15, except that the substrate membrane 4 produced in Production Example 4 was used. The composition and physical properties of the obtained separator are shown in Tables 3 to 5.

### Example 18

A separator having an inorganic porous layer on either side of the substrate membrane 1 was produced by producing inorganic layers in the same manner as in Example 15 on both sides of the substrate membrane 1. The composition and physical properties of the obtained separator are shown in Tables 3 to 5.

### Example 19

An inorganic dispersion was produced by uniformly dispersing with a homogenizer a mixed solution of 50 mass % of colloidal silica (inorganic filler C), having a solid content concentration of 20 mass % and a dispersion average particle size of 0.01 μm and 50 mass % of ethanol. A coating solution was produced in the same manner as in Example 1 by adding 3 mass % of polyvinyl alcohol as a binder based on the inorganic filler.

This coating solution was coated on a surface (one face) of the substrate membrane 1 using a gravure coater. Then, the water was removed by drying at 60° C. The composition and physical properties of the obtained separator are shown in Tables 3 to 5.

### Example 20

A separator was produced in the same manner as in Example 13, except that alumina (inorganic filler D) having a dispersion average particle size 0.7 μm was used. The composition and physical properties of the obtained separator are shown in Tables 3 to 5.

### Example 21

A separator was produced in the same manner as in Example 13, except that titania (inorganic filler E) having a dispersion average particle size 0.4 μm was used. The composition and physical properties of the obtained separator are shown in Tables 3 to 5.

### Example 22

A binder solution was produced by mixing 10 mass % of polyvinyl alcohol (PVA) (resin density 1.28 g/cm³, average degree of polymerization 1,700, degree of saponification 99% or more) and 90 mass % of distilled water, and adjusting the solid content concentration to 10 mass %.

1 g of this binder solution was added to 200 g of the inorganic dispersion produced in Example 1 to produce a coating solution. The binder concentration based on the inorganic filler at this stage was 0.5 mass %.

This coating solution was coated on a surface of the substrate membrane 1 using a gravure coater. Then, the solvent was removed by drying at 60° C. The composition and physical properties of the obtained separator are shown in Tables 3 to 5.

### Example 23

1 g of the binder solution produced in Example 22 was added to 20 g of the inorganic dispersion produced in Example 1 to produce a coating solution. The binder concentration based on the inorganic filler at this stage was 5 mass %.

This coating solution was coated on a surface of the substrate membrane 1 produced in Production Example 1 using a gravure coater. Then, the solvent was removed by drying at 60° C. The composition and physical properties of the obtained separator are shown in Tables 3 to 5.

### Example 24

7 g of the binder solution produced in Example 22 was added to 20 g of the inorganic dispersion produced in Example 1 to produce a coating solution. The binder concentration based on the inorganic filler at this stage was 35 mass %.

This coating solution was coated on a surface of the substrate membrane 1 using a gravure coater. Then, the solvent was removed by drying at 60° C. The composition and physical properties of the obtained separator are shown in Tables 3 to 5.

### Example 25

0.2 g of a binder solution of SB latex (resin density 0.93 g/cm³, solid component concentration 50%, lowest film-forming temperature 0° C. or less) was added to 20 g of the inorganic dispersion produced in Example 1 to produce a coating solution. The binder concentration based on the inorganic filler at this stage was 5 mass %.

This coating solution was coated on a surface of the substrate membrane 1 using a gravure coater. Then, the solvent was removed by drying at 60° C. The composition and physical properties of the obtained separator are shown in Tables 3 to 5.

### Comparative Example 1

Substrate membrane 1 was used as is as a separator. The composition and physical properties of the separator are shown in Tables 3 to 5.

### Comparative Example 2

Substrate membrane 4 was used as is as a separator. The composition and physical properties of the separator are shown in Tables 3 to 5.

### Comparative Example 3

A surface (one face) of the substrate membrane 1 was coated with a silane coupling agent. Next, the substrate membrane 1 was dipped in a mixed solution of 20 mass % of 3-glycidoxypropyltrimethoxysilane (manufactured by Nippon Unicar Company Limited, trade name “A-187”) and 80 mass % ethanol. Then, the ethanol was removed by drying at 60° C. The composition and physical properties of the obtained separator are shown in Tables 3 to 5.

### Comparative Example 4

A fluorinated ion-exchange resin was supported on a surface (one face) of the substrate membrane 1. Next, as a fluorinated ion-exchange resin, Nafion™ (manufactured by Dupont, trade name) was dissolved in ethanol to produce a 5 mass % solution. The substrate membrane 1 was dipped in this solution, and in that state placed in a vacuum dessicator, and deaerated for 2 hours. Subsequently, the membrane was lifted from the solution, dried in air, and then dried for 2 hours in an 80° C. hot bath. The composition and physical properties of the obtained separator are shown in Tables 3 to 5.

TABLE 1

| | | Dispersion Average | M Value |
|---|---|---|---|
| | Material | Particle Size (μm) | (Vol %) |
| Inorganic Filler A | Hydrophilic wet- | 2.00 | 0 |
| | process silica | | |
| Inorganic Filler B | Dry silica | 0.25 | 0 |
| Inorganic Filler C | Colloidal silica | 0.01 | 0 |
| Inorganic Filler D | Alumina | 0.70 | 0 |
| Inorganic Filler E | Titania | 0.40 | 0 |
| Inorganic Filler F | Wet-process silica | 0.60 | 0 |

TABLE 2

| | | Substrate Membrane Physical Properties | | | | | | |
|---|---|---|---|---|---|---|---|---|
| | | | | | | | Initial Bromine | Electrical |
| | | | | Air | | Si/C | Diffusion | Resistance |
| | Inorganic | Thickness | Porosity | Permeability | [η] | Ratio | Coefficient ×10⁻⁹ | Ω · 100 cm²/ |
| | Filler | μm | % | sec/100 cc/μm | dl/g | (-) | mol/cm²/sec | Sheet |
| Substrate | Inorganic | 600 | 58 | 6.0 | 6.1 | 0.17 | 4.8 | 0.0015 |
| Membrane 1 | Filler A | | | | | | | |
| Substrate | Inorganic | 400 | 58 | 6.0 | 6.1 | 0.17 | 7.2 | 0.0011 |
| Membrane 2 | Filler A | | | | | | | |
| Substrate | Inorganic | 600 | 55 | 7.0 | 5.5 | 0.04 | 6.8 | 0.0021 |
| Membrane 3 | Filler A | | | | | | | |
| Substrate | Inorganic | 600 | 55 | 5.5 | 3.2 | 0.50 | 4.4 | 0.0013 |
| Membrane 4 | Filler A | | | | | | | |

TABLE 3

| | | | | Binder |
|---|---|---|---|---|
| | Substrate | Inorganic Porous | | Composition |
| | Membrane | Layer | Binder | Mass % |
| Example 1 | 1 | Inorganic Filler B | MES51 | 5 |
| Example 2 | 1 | Inorganic Filler B | MES51 | 10 |
| Example 3 | 1 | Inorganic Filler B | ES40 | 5 |
| Example 4 | 1 | Inorganic Filler B | MES51 | 5 |
| Example 5 | 1 | Inorganic Filler C | MES51 | 5 |
| Example 6 | 1 | Inorganic Filler C | MS56 | 5 |
| Example 7 | 1 | Inorganic Filler C | MS56 | 5 |
| Example 8 | 1 | Inorganic Filler C | MS56 | 5 |
| Example 9 | 1 | Inorganic Filler D | MES51 | 5 |
| Example 10 | 1 | Inorganic Filler E | MES51 | 5 |
| Example 11 | 2 | Inorganic Filler C | MS56 | 5 |
| Example 12 | 3 | Inorganic Filler C | MS56 | 5 |
| Example 13 | 1 | Inorganic Filler A | PVA | 4 |
| Example 14 | 1 | Inorganic Filler F | PVA | 4 |
| Example 15 | 1 | Inorganic Filler B | PVA | 4 |
| Example 16 | 2 | Inorganic Filler B | PVA | 4 |
| Example 17 | 4 | Inorganic Filler B | PVA | 4 |
| Example 18 | 1 | Inorganic Filler B | PVA | 4 |
| Example 19 | 1 | Inorganic Filler C | PVA | 3 |
| Example 20 | 1 | Inorganic Filler D | PVA | 4 |
| Example 21 | 1 | Inorganic Filler E | PVA | 4 |
| Example 22 | 1 | Inorganic Filler B | PVA | 0.5 |
| Example 23 | 1 | Inorganic Filler B | PVA | 5 |
| Example 24 | 1 | Inorganic Filler B | PVA | 35 |
| Example 25 | 1 | Inorganic Filler B | SB | 5 |
| Comparative | 1 | — | — | — |
| Example 1 | | | | |
| Comparative | 4 | — | — | — |
| Example 2 | | | | |
| Comparative | 1 | — | — | — |
| Example 3 | | | | |
| Comparative | 1 | — | — | — |
| Example 4 | | | | |

TABLE 4

| | Separator Properties | | | | | | |
|---|---|---|---|---|---|---|---|
| | | | | | | Bromine | Bromine |
| | | | | | Initial | Diffusion | Diffusion |
| | | Inorganic | | Electrical | Bromine | Coefficient | Coefficient |
| | | Porous Layer | Air | Resistance | Diffusion | After 240 | After 720 |
| | Thickness | Thickness | Permeability | Ω · 100 cm²/ | Coefficient ×10⁻⁹ | Hours ×10⁻⁹ | Hours ×10⁻⁹ |
| | μm | μm | sec/100 ml/μm | Sheet | mol/cm²/sec | mol/cm²/sec | mol/cm²/sec |
| Example 1 | 610 | 10 | 6.2 | 0.0016 | 2.3 | 2.3 | 2.6 |
| Example 2 | 610 | 10 | 6.3 | 0.0016 | 2.3 | 2.3 | 2.4 |
| Example 3 | 610 | 10 | 6.2 | 0.0016 | 2.3 | 2.3 | 2.6 |
| Example 4 | 610 | 10 | 6.1 | 0.0015 | 2.3 | 2.3 | 2.5 |
| Example 5 | 605 | 5 | 6.0 | 0.0015 | 2.1 | 2.1 | 2.3 |
| Example 6 | 605 | 5 | 6.0 | 0.0015 | 2.1 | 2.1 | 2.3 |
| Example 7 | 610 | 10 | 6.2 | 0.0016 | 1.8 | 1.8 | 1.9 |
| Example 8 | 610 | 10 | 6.3 | 0.0017 | 1.8 | 1.8 | 1.9 |
| Example 9 | 610 | 10 | 6.0 | 0.0015 | 2.3 | 2.3 | 2.7 |
| Example 10 | 610 | 10 | 6.0 | 0.0015 | 2.3 | 2.3 | 2.7 |
| Example 11 | 405 | 10 | 6.0 | 0.0011 | 2.4 | 2.4 | 2.5 |
| Example 12 | 605 | 10 | 7.0 | 0.0021 | 2.3 | 2.3 | 2.5 |
| Example 13 | 620 | 20 | 6.1 | 0.0016 | 2.6 | 2.9 | 4.7 |
| Example 14 | 610 | 10 | 6.2 | 0.0016 | 2.3 | 2.6 | 4.5 |
| Example 15 | 610 | 10 | 6.3 | 0.0017 | 2.1 | 2.3 | 4.5 |
| Example 16 | 410 | 10 | 6.6 | 0.0012 | 2.4 | 2.4 | 4.6 |
| Example 17 | 610 | 10 | 5.6 | 0.0014 | 2.1 | 2.3 | 4.6 |
| Example 18 | 620 | 20 | 6.1 | 0.0017 | 2.0 | 2.2 | 4.5 |
| Example 19 | 605 | 5 | 6.0 | 0.0016 | 1.8 | 1.9 | 4.3 |
| Example 20 | 610 | 10 | 5.9 | 0.0015 | 2.3 | 2.5 | 4.7 |
| Example 21 | 610 | 10 | 5.9 | 0.0015 | 2.2 | 2.4 | 4.7 |
| Example 22 | 605 | 5 | 6.1 | 0.0016 | 2.6 | 2.9 | 4.7 |
| Example 23 | 610 | 10 | 6.6 | 0.0018 | 2.4 | 2.8 | 4.2 |
| Example 24 | 620 | 20 | 12 | 0.0050 | 2.2 | 2.7 | 3.9 |
| Example 25 | 610 | 10 | 6.6 | 0.0018 | 2.4 | 2.8 | 4.2 |
| Comparative | 600 | — | 6.0 | 0.0015 | 4.8 | 4.9 | 6.3 |
| Example 1 | | | | | | | |
| Comparative | 600 | — | 5.5 | 0.0013 | 4.4 | 4.5 | 6.2 |
| Example 2 | | | | | | | |
| Comparative | 610 | — | 7.4 | 0.0030 | 3.6 | 4.2 | 6.1 |
| Example 3 | | | | | | | |
| Comparative | 610 | — | 12.0 | 0.0050 | 2.6 | 4.4 | 6.2 |
| Example 4 | | | | | | | |

TABLE 5

| | Separator Properties | | | | | | | | |
|---|---|---|---|---|---|---|---|---|---|
| | Tensile Breaking | | Tensile Breaking | | | | | Initial | |
| | Strength | | Elongation | | Pencil | Crack | Wettability | Coulombic | Coulomb |
| | MD MPa | TD MPa | MD % | TD % | Hardness | Resistance % | Seconds/10 μl | Efficiency % | Maintenance % |
| Example 1 | 6.4 | 4.6 | 220 | 240 | 6H | 0 | 10 | 90 | 85 |
| Example 2 | 6.4 | 4.6 | 220 | 240 | 6H | 0 | 10 | 95 | 90 |
| Example 3 | 6.4 | 4.6 | 220 | 240 | 6H | 0 | 10 | 90 | 85 |
| Example 4 | 6.4 | 4.6 | 220 | 240 | 6H | 0 | 10 | 90 | 85 |
| Example 5 | 6.5 | 4.7 | 220 | 240 | 6H | 0 | 10 | 95 | 90 |
| Example 6 | 6.5 | 4.7 | 220 | 240 | 6H | 0 | 10 | 95 | 90 |
| Example 7 | 6.5 | 4.7 | 220 | 240 | 6H | 0 | 10 | 95 | 95 |
| Example 8 | 6.6 | 4.8 | 220 | 240 | 6H | 0 | 10 | 95 | 95 |
| Example 9 | 6.5 | 4.7 | 220 | 240 | 5H | 0 | 10 | 90 | 85 |
| Example 10 | 6.5 | 4.7 | 220 | 240 | 5H | 0 | 10 | 90 | 85 |
| Example 11 | 6.4 | 4.7 | 220 | 240 | 6H | 0 | 10 | 95 | 90 |
| Example 12 | 6.8 | 4.9 | 280 | 290 | 5H | 0 | 10 | 90 | 85 |
| Example 13 | 6.3 | 4.5 | 220 | 240 | 2B | 0 | 10 | 90 | 60 |
| Example 14 | 6.5 | 4.8 | 230 | 250 | 2B | 0 | 10 | 90 | 60 |
| Example 15 | 6.4 | 4.7 | 220 | 240 | 2B | 0 | 5 | 90 | 60 |
| Example 16 | 6.4 | 4.7 | 220 | 240 | 2B | 0 | 5 | 90 | 60 |
| Example 17 | 6.5 | 4.7 | 230 | 240 | 2B | 0 | 5 | 90 | 60 |
| Example 18 | 6.4 | 4.7 | 220 | 250 | 2B | 0 | 5 | 95 | 60 |
| Example 19 | 6.6 | 4.9 | 230 | 250 | 2B | 0 | 5 | 95 | 60 |
| Example 20 | 6.5 | 4.7 | 220 | 240 | 2B | 0 | 10 | 90 | 60 |
| Example 21 | 6.5 | 4.8 | 220 | 240 | 2B | 0 | 10 | 90 | 60 |
| Example 22 | 6.2 | 4.5 | 220 | 240 | 4B | 0 | 10 | 85 | 55 |
| Example 23 | 6.4 | 4.6 | 220 | 240 | 2B | 0 | 10 | 85 | 60 |
| Example 24 | 6.4 | 4.7 | 220 | 240 | HB | 0 | 10 | 85 | 55 |
| Example 25 | 6.3 | 4.5 | 220 | 240 | 2B | 0 | 10 | 85 | 60 |
| Comparative | 6.2 | 4.5 | 220 | 240 | — | 0 | 50 | 60 | 50 |
| Example 1 | | | | | | | | | |
| Comparative | 2.4 | 2.1 | 80 | 90 | — | 25 | 35 | 65 | 45 |
| Example 2 | | | | | | | | | |
| Comparative | 6.3 | 4.5 | 220 | 240 | — | 0 | 120 | 60 | 45 |
| Example 3 | | | | | | | | | |
| Comparative | 6.2 | 4.5 | 220 | 240 | — | 0 | 20 | 55 | 35 |
| Example 4 | | | | | | | | | |

From the results of Tables 3 to 5, it can be seen that the separator of the present embodiment is a separator for a metal halide battery capable of maintaining bromine permeability for a long duration, and maintaining battery performance for a long duration.

Further, all of the separators of Example 1 to 25 exhibited excellent crack resistance, with a crack resistance as measured by the following evaluation method of 0%.

### Crack Resistance of Separator (%)

Crack resistance of separator was evaluated as the ratio of the number of separators in which cracking occurred in the membrane when 20 separators were welded by ultrasonic welding to a frame made from polyethylene. The ultrasonic welding conditions were a power of 1,200 W, an oscillation frequency of 20 kHz, a pressing pressure of 0.5 MPa.

This application is based on Japanese patent application (Japanese Patent Application No. 2008-026476) filed on Feb. 6, 2008, and Japanese patent application (Japanese Patent Application No. 2008-082591) filed on Mar. 27, 2008, which are hereby incorporated by reference herein in their entirety.

### INDUSTRIAL APPLICABILITY

The separator for a metal halide battery according to the present invention can maintain a low bromine permeability for a long duration, and maintain battery performance for a long duration.

1. A separator for a metal halide battery having a bromine diffusion coefficient after 240 hours of less than 4.2×10⁻⁹ mol/cm²/sec.

2. The separator according to claim 1, which has an electrical resistance of 0.005 ω·100 cm²/sheet or less.

3. The separator according to claim 1 or 2, which has a tensile breaking strength of 2.5 MPa or more.

4. A separator for a metal halide battery comprising:
a polyolefin porous layer which comprises a polyolefin as a main component; and
an inorganic filler porous layer which is laminated on the polyolefin porous layer and which comprises an inorganic filler (I) as a main component.

5. The separator according to claim 4, wherein the inorganic filler porous layer further comprises a binder.

6. The separator according to claim 5, wherein the binder is an inorganic binder.

7. The separator according to claim 6, wherein the inorganic binder comprises a metal oxide as a main component.

8. The separator according to any one of claims 4 to 7, wherein the inorganic filler (I) has a dispersion average particle size of 0.005 to 5 μm.

9. The separator according to any one of claims 4 to 8, wherein the inorganic filler (I) comprises silicon oxide as a main component.

10. The separator according to any one of claims 4 to 9, wherein the inorganic filler (I) is hydrophilic.

11. The separator according to any one of claims 4 to 10, wherein the polyolefin porous layer further comprises an inorganic filler (II).

12. The separator according to claim 11, wherein the inorganic filler (II) comprises silicon oxide as a main component.

13. The separator according to claim 12, wherein a ratio (Si/C ratio) between the number of silicon atoms and the number of carbon atoms on a surface of the polyolefin microporous membrane facing the inorganic filler porous layer is 0.005 to 0.45.

14. The separator according to any one of claims 1 to 13, which is for a zinc-bromine battery.
